(19) United States
(12) Patent Application Publication
(10) Pub. No.: US 2020/0104664 A1
(43) Pub. Date: Apr. 2, 2020

(54) LANDMARK TAPE AND LANDMARK DISPENSER

(71) Applicant: SIEMENS AKTIENGESELLSCHAFT, MÜNCHEN (DE)

(72) Inventors: Wendelin FEITEN, Neubiberg (DE); Thomas WÖSCH, MÜNCHEN (DE)

(21) Appl. No.: 16/578,607

(22) Filed: Sep. 23, 2019

(30) Foreign Application Priority Data
Sep. 27, 2018 (EP) 18197229.0

(51) Int. Cl. G06K 19/06; B65H 16/00; B65H 16/02; G01C 21/20

(52) U.S. Cl. CPC G06K 19/06037; B65H 16/005; G06K 19/06028; G01C 21/20; B65H 16/02

(57) ABSTRACT

Provided is a machine-readable structure for the spatial orientation of robots, vehicles or other self-orienting systems are applied to a landmark tape. The landmark tape has a multiplicity of separation points for separating tape segments of selectable size that are usable as landmarks. Here, the machine-readable structures are randomly distributed over the landmark tape. A landmark dispenser according to the embodiments comprise a separating apparatus for separating tape segments of a landmark tape. Here, it is possible to dispense with separation points in the landmark tape itself.

### CROSS-REFERENCE TO RELATED APPLICATIONS

This application claims priority to European Application No. 18197229.0, having a filing date of Sep. 27, 2018, the entire contents of which are hereby incorporated by reference.

### FIELD OF TECHNOLOGY

Mobile robots and, in particular, autonomous robots must often ascertain their own position and/or alignment in respect of their use surroundings, i.e., they must orient themselves in their surroundings in order to be able to navigate and act reliably. The same applies to many vehicles or other self-orienting systems, such as self-adjusting surgical instruments, for example.

### BACKGROUND

Sensors such as laser scanners or cameras, for example, are often used for orientation purposes; these sensors are used to identify features that occur in the surroundings or features that are specifically attached to this end, so-called landmarks. Then, the own orientation with respect to these landmarks can be derived on the basis of the identified landmarks.

However, landmarks occurring naturally in the surroundings often do not suffice for a reliable orientation. In such cases, artificial landmarks are usually attached in the surroundings in targeted fashion. Such artificial landmarks should be machine-identifiable, machine-readable, distinguishable from one another and localizable to the best possible extent. Furthermore, there should be no substantial change therein over time.

Producing and printing different geometric patterns and attaching the printouts as landmarks in the use surroundings is known. A disadvantage with known apparatuses and methods is that a set with a multiplicity of different markers has to be kept available in each case. To the extent that the markers, as a rule, cannot be recognized and identified equally well from any distance, marker sets of different size need often be kept available, depending on use conditions.

### SUMMARY

An aspect relates to a landmark tape and a landmark dispenser that simplify an orientation-assisting preparation of use surroundings of robots, vehicles and other self-orienting systems. According to embodiments of the invention, provision is made of a landmark tape with applied machine-readable structures for the spatial orientation of robots, vehicles or other self-orienting systems. The landmark tape has a multiplicity of separation points for separating tape segments of selectable size that are usable as landmarks. Here, the machine-readable structures are randomly distributed over the landmark tape.

Furthermore, provision is made of a landmark dispenser according to embodiments of the invention comprising a landmark tape with applied machine-readable structures for the spatial orientation of robots, vehicles or other self-orienting systems. The landmark dispenser comprises a separating apparatus for separating tape segments of the landmark tape that are usable as landmarks. Here, the machine-readable structures are randomly distributed over the landmark tape.

As a result of the random distribution, more particularly the pseudo-random or quasi-random distribution, of the machine-readable structures, separated tape segments differ from one another with a probability that increases, greatly as a rule, with a size or length of the respective tape segment. Hence, a user can obtain landmarks that are distinguishable from one another with sufficient probability by simple separation of tape segments of suitable size. By way of example, if only a few landmarks have to be attached in small rooms, it is only necessary to distinguish between a few landmarks as well. Accordingly, shorter tape segments can be used as landmarks in such a case. By contrast, if a relatively large number of landmarks should be attached, for example in relatively large rooms or outdoors, relatively long tape segments can readily be separated and used as landmarks. Consequently, the tape segments can be used as landmarks in a multiplicity of different use surroundings. A substantial advantage should be considered to be the fact that, in particular, there is no need for a relatively large store of markers that are different a priori in order to prepare different use surroundings. Instead, the same landmark tape can be used for different surroundings and different use purposes.

Embodiments and developments of the invention are specified in the dependent claims.

According to embodiments of the invention, the landmark tape can be wound up into a roll, in particular on a shaft, coil, tube or drum.

Furthermore, a geometric arrangement, a geometric form, a geometric pattern, a reflectivity, a luminosity and/or a color of the machine-readable structures can have a random distribution, in particular in one dimension or in two dimensions. Here, in particular, the machine-readable structures can comprise randomly distributed reflectors, such as so-called cat's eyes, for example, mirroring surfaces or actively luminous tape sections.

Moreover, the machine-readable structures can have geometric patterns of different sizes and/or different types. In many cases, this allows the machine-readable structures to be identified from different distances.

Advantageously, the machine-readable structures may comprise tape sections with substantially uniform reflectivity situated between adjacent separation points, wherein the reflectivities of various such tape sections have a random distribution. As a rule, such uniformly colored tape sections can be identified particularly reliably by laser scanners or cameras.

Furthermore, the machine-readable structures may be configured like a barcode, a Quick Response (QR) code and/or an aruco marker. In this case, a multiplicity of commercially available scanners or identification methods can be used for identifying the tape segments.

According to embodiments of the invention, a fastening means, in particular an adhesive layer, an adhesive film, a magnetic layer and/or a hook-and-loop tape, can be provided for fastening a respectively separated tape segment in surroundings provided for spatial orientation purposes. The fastening means can be attached to the other side of the landmark tape to that of the machine-readable structures.

### BRIEF DESCRIPTION

Some of the embodiments will be described in detail, with reference to the following figures, wherein like designations denote like members, wherein:

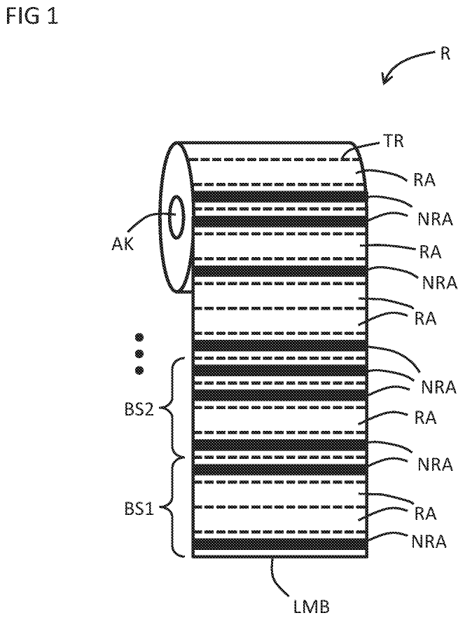

FIG. 1 shows a landmark tape according to embodiments of the invention;

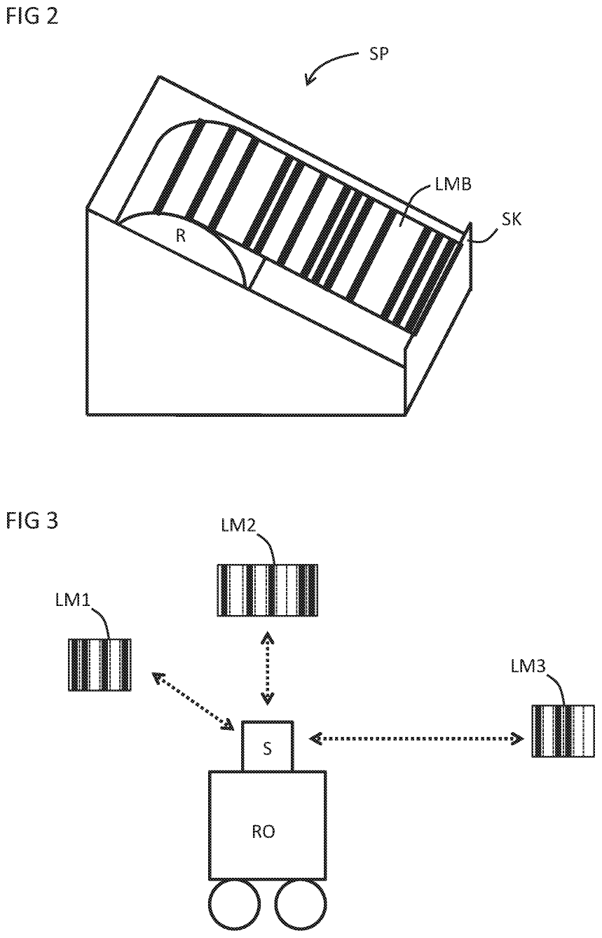

FIG. 2 shows a landmark dispenser according to embodiments of the invention; and

FIG. 3 shows a mobile robot during navigation on the basis of landmarks attached in its surroundings according to embodiments of the invention.

### DETAILED DESCRIPTION

FIG. 1 shows a schematic illustration of a landmark tape LMB according to embodiments of the invention with applied machine-readable structures RA and NRA, which serve for the spatial orientation of mobile, more particularly autonomous, robots, vehicles or other self-orienting systems or apparatuses.

In this context, spatial orientation should be understood to mean, in particular, determining, ascertaining or capturing a position and/or alignment of the self-orienting system in respect of use surroundings. For the present exemplary embodiment, the assumption is made that the self-orienting system is an autonomous mobile robot.

The landmark tape LMB is wound up into a roll R on a cylindrical unrolling body AK, for example a coil, tube or drum. The unrolling body AK may have an opening allowing it to be plugged on a shaft of an unrolling device. Moreover, a roll opening of the roll R can also be left clear for this purpose.

The landmark tape LMB has a multiplicity of separation points TR attached at regular distances, which may be at equidistant distances, the separation points being elucidated in FIG. 1 by dashed lines. The separation points TR are configured in such a way that tape segments of the landmark tape LMB can easily be separated by hand at the separation points TR. The separation points TR may be realized by a perforation of the landmark tape LMB in each case.

In the present exemplary embodiment, the machine-readable structures are realized by reflecting tape sections RA and non-reflecting or less reflecting tape sections NRA. The tape sections RA and NRA each form an area with substantially uniform reflectivity arranged between adjacent separation points TR. The reflecting tape sections RA can have a uniform white color and the non-reflecting tape sections NRA can have a uniform black color. Such structures can be identified particularly easily by laser scanners or cameras. As an alternative or in addition thereto, the tape sections can be labeled or marked by different colors, forms, widths, lengths and/or distances. Moreover, reflectors, such as, e.g., so-called cat's eyes, mirroring surfaces or actively luminous tape sections can also be provided as machine-readable structures.

According to embodiments of the invention, the reflectivities, coloring or other labeling of different such tape sections have a random distribution over the landmark tape LMB. In particular, such a random distribution should be understood to mean a distribution, arrangement or selection, derived from random numbers, pseudo-random numbers and/or quasi-random numbers, of the reflectivities or other labeling of the various tape sections. Thus, a respective tape section can be colored black with a predeterminable probability p of 0.5, for example, or can be left white with a probability of 1−p.

As an alternative or in addition thereto, provision can be made of a so-called quasi-random distribution which is constructed in a targeted manner in such a way that arbitrary sequences of successive tape sections do not correspond with a probability that is as high as possible or at least sufficiently high. Such quasi-random distributions are often also referred to as sub-random distributions or low-discrepancy distributions.

Consequently, the sequence of tape sections RA and NRA can be interpreted as a random or quasi-random sequence of zeros (e.g., for the non-reflecting tape sections) and ones (e.g., for the reflecting tape sections). A tape segment comprising a plurality of tape sections consequently yields an individual code that is different from the codes of other tape segments, as a rule with a sufficiently high probability. It is self-evident that this probability increases greatly with the length of a respective tape segment.

At the separation points TR, tape segments with an ad-hoc-selectable length can be separated manually by the user in a simple manner. The longer the separated tape segments, the higher the probability that the codes thereof differ. Two such tape segments BS1 and BS2 are illustrated in exemplary fashion in FIG. 1. According to embodiments of the invention, these separated tape segments, in this case BS1 and BS2, can be used as landmarks that should be attached in the surroundings of the mobile robot such that the mobile robot can use these to spatially orientate itself.

An aspect according to embodiments of the invention is that, on account of the tape segment-overarching random distribution of the tape sections RA and NRA, the user can easily choose, in situ and ad hoc, how small the probability should be of a random correspondence between different landmarks by separating a longer or shorter tape segment from the same roll R. By way of example, if only a few landmarks should be attached in small rooms, it is necessary for only a few codes to be distinguished. Accordingly, shorter tape segments can be used as landmarks in such a case. By contrast, if a larger number of landmarks should be attached, for example in relatively large rooms or outdoors, longer tape segments can readily be separated from the same roll R and can be attached as landmarks that are very probably distinguishable.

Consequently, if use is made of embodiments of the invention, there is no need for a relatively large store of markers that are different a priori in order to prepare different use surroundings.

In the present exemplary embodiment, the landmark tape LMB, as it were, has a barcode that runs over the entire tape length. As an alternative or in addition thereto, QR codes and/or aruco markers may also be applied to the landmark tape as machine-readable structures.

Furthermore, randomly distributed strips with a large width and/or relatively large randomly distributed patterns may be provided so that a respective landmark can also be recognized and identified from a relatively large distance.

Irrespective thereof, information can then often be derived from a landmark according to embodiments of the invention even if the machine-readable structures can no longer be resolved individually from a relatively large distance. If a landmark is captured from such a distance, e.g., by a beam of a laser scanner, a plurality of tape sections RA and/or NRA fall into the beam as a rule, and so it is a mean value of the reflectivities integrated over the beam that is measured. Since the reflectivities have a random distribution, the respective mean values likewise have a random dependence. Consequently, a random sequence can be derived again as a fingerprint, as it were, by measuring a plurality of beams striking the relevant landmark, the fingerprint being able to serve to distinguish this landmark from other landmarks. By way of example, such a random sequence can be formed by virtue of detecting whether a respective mean value is greater than or less than a predetermined threshold, e.g., 0.5. Depending thereon, a 0 or a 1 can be assigned in each case.

In order to attach the separated tape segments, BS1 and BS2 in this case, as landmarks in the use surroundings of the robot, the landmark tape has an adhesive film (not illustrated) as a fastening means on its back side, i.e., on the other side to that of the machine-readable structures RA and NRA. The adhesive film may be provided with a protective film that is easily removable and non-adhesive on its back side. Using the adhesive film, the separated landmarks can easily be adhesively bonded to suitable room elements, such as walls, ceilings, doors and/or other articles in the use surroundings. As an alternative or in addition to the adhesive layer, provision can be made of a magnetic layer, a hook-and-loop tape or any other fastening means suitable for the respective use surroundings. The perforation of the separation points TR may extend through the fastening means such that the landmarks are easily separable.

FIG. 2 shows a schematic illustration of a landmark dispenser SP according to embodiments of the invention, comprising a landmark tape LMB wound up into a roll R. The roll R is attached to an unrolling device, for example an unrolling shaft of the landmark dispenser SP.

The landmark tape LMB has—as described in conjunction with FIG. 1—a randomly distributed sequence of reflecting and non-reflecting tape sections as machine-readable structures. A tape segment, which comprises a sufficient number of such tape sections, can be used as an individual code and hence as a landmark, as already explained above.

The back side of the landmark tape may have been provided with an adhesive layer as a fastening means for fastening a respectively separated tape segment in the use surroundings.

For the purposes of separating tape segments, usable as landmarks, of the landmark tape LMB, the landmark dispenser SP comprises a cutting edge SK as a separating apparatus. The landmark tape LMB inserted in the landmark dispenser lies with its adhesive layer on the cutting edge SK and it is easily affixed by way of the adhesive layer. On account of the separating apparatus SK, separation points in the landmark tape LMB itself can be dispensed with in many cases.

By means of the described arrangement, a user is very easily able to pull tape segments of the landmark tape LMB with an ad-hoc-selectable length out of the landmark dispenser SP, separate the tape segments at the cutting edge SK and attach the tape segments in the use surroundings as landmarks by means of the adhesive layer.

FIG. 3 shows a schematic illustration of an autonomous mobile robot RO when navigating on the basis of landmarks LM1, LM2 and LM3, which are attached in its surroundings. By way of example, the robot can be a manufacturing robot, a transport robot, a diving robot or a drone. As an alternative or in addition thereto, embodiments of the invention can also be used for orientation or navigation assistance for other self-orienting systems, such as, e.g., autonomous vehicles or self-adjusting surgical instruments.

For spatial orientation purposes, i.e., for determining its own position and/or alignment in respect of its surroundings, the robot RO comprises a scanner S, such as a laser scanner and/or a camera with an object identification device. A scan plane of the scanner S can be aligned vertically or horizontally, in particular. The scanner S may have a swivelable configuration such that the scan plane is movable about the vertical axis or any other spatial axis.

The landmarks LM1, LM2 and LM3 were separated as tape segments from a landmark tape according to embodiments of the invention and/or a landmark dispenser according to embodiments of the invention and were attached in the surroundings of the robot RO. Here, the length of the tape segments LM1, LM2 and LM3 was chosen—as described above—in such a way that the illustrated codes have a sufficient probability of being pairwise different. A spatial information item about the respective attachment location can be assigned to the landmarks LM1, LM2 and LM3 in each case.

The scanner S scans the surroundings of the robot RO and identifies the landmarks LM1, LM2 and LM3 in the process. By evaluating the scan signals, the scanner S is able to ascertain a direction, a distance and the individual code of the respective landmark LM1, LM2 or LM3. Using standard geometric methods, the robot RO can ascertain its position and orientation in respect of the landmarks LM1, LM2 and LM3, and hence in respect of its surroundings, from these specifications and can use these for navigation purposes.

The embodiments can significantly simplify a preparation of use surroundings of mobile robots or other self-orienting systems. Moreover, embodiments of the invention are equally suitable for a multiplicity of different use surroundings.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A landmark tape with applied machine-readable structures for the spatial orientation of robots, vehicles or other self-orienting systems, wherein the landmark tape has a multiplicity of separation points for separating tape segments of selectable size that are usable as landmarks, and the machine-readable structures are randomly distributed over the landmark tape.

2. The landmark tape as claimed in claim 1, wherein the landmark tape is wound up into a roll.

3. The landmark tape as claimed in claim 1, wherein a geometric arrangement, a geometric form, a geometric pattern, a reflectivity, a luminosity and/or a color of the machine-readable structures has a random distribution.

4. The landmark tape as claimed in claim 1, wherein the machine-readable structures have geometric patterns of different sizes and/or different types.

5. The landmark tape as claimed in claim 1, wherein the machine-readable structures comprise tape sections with substantially uniform reflectivity situated between adjacent separation points, wherein the reflectivities of various such tape sections have a random distribution.

6. The landmark tape as claimed in claim 1, wherein the machine-readable structures are configured as a barcode, a QR code and/or an aruco marker.

7. The landmark tape as claimed in claim 1, wherein the separation points have a perforation.

8. The landmark tape as claimed in claim 1, wherein a fastening means for fastening a respectively separated tape segment in surroundings provided for spatial orientation purposes.

9. A landmark dispenser, comprising:
a landmark tape with applied machine-readable structures for the spatial orientation of robots, vehicles or other self-orienting systems,
a separating apparatus for separating tape segments of the landmark tape that are usable as landmarks, and
wherein the machine-readable structures are randomly distributed over the landmark tape.

10. The landmark dispenser as claimed in claim 9, wherein the landmark tape is wound up into a roll and in that an unrolling device is provided for receiving and unrolling the roll.

11. The landmark dispenser as claimed in claim 9, wherein the landmark tape is configured with applied machine-readable structures for the spatial orientation of robots, vehicles or other self-orienting systems, wherein the landmark tape has a multiplicity of separation points for separating tape segments of selectable size that are usable as landmarks, and the machine-readable structures are randomly distributed over the landmark tape.
